(19) United States
(12) Patent Application Publication
(10) Pub. No.: US 2014/0240366 A1
(43) Pub. Date: Aug. 28, 2014

(54) DISPLAY DEVICE FOR REDUCING DYNAMIC FALSE CONTOUR

(71) Applicant: Samsung Display Co., Ltd., Yongin-City (KR)

(72) Inventors: Dong-Won Lee, Yongin-City (KR); Hee-Chul Hwang, Yongin-City (KR); Ji-Eun Park, Yongin-City (KR); Jun-Gyu Lee, Yongin-City (KR); Joo-Hyung Lee, Yongin-City (KR)

(21) Appl. No.: 13/929,607

(22) Filed: Jun. 27, 2013

(30) Foreign Application Priority Data
Feb. 25, 2013 (KR) 10-2013-0019944

(51) Int. Cl. G09G 3/20

(52) U.S. Cl. CPC G09G 3/2003
USPC 345/690; 345/30

(57) ABSTRACT

A display device with reduced dynamic false contouring effect is disclosed. In one aspect, the device includes a display unit including a plurality of pixels and a timing controller. The timing controller is configured to determine a grayscale value of an image frame based on a grayscale distribution of the image frame. The controller is further configured to determine an arrangement of sub-frames as a driving mode based on the determined grayscale.

### CROSS-REFERENCE TO RELATED APPLICATION

This application claims priority to and the benefit of Korean Patent Application No. 10-2013-0019944 filed in the Korean Intellectual Property Office on Feb. 25, 2013, the entire contents of which are incorporated herein by reference.

### BACKGROUND

1. Field

The disclosed technology generally relates to a display device, and more particularly to a display device with reduced dynamic false contouring effects for improved image quality.

2. Description of the Related Technology

Recently, various flat panel displays have been developed. Flat panel displays can overcome many drawbacks of cathode ray tubes (CRT), such as heavy weight and large volume. Flat panel displays include liquid crystal displays (LCD), field emission displays (FED), plasma display panels (PDP), and organic light emitting diode (OLED) displays, among others.

An organic light emitting diode (OLED) display displays an image using organic light emitting diodes (OLED) that generate light via recombination of electrons and holes. OLED displays have been recognized for certain advantageous attributes such as low power consumption, fast response speed, high illumination efficiency, and excellent luminance and viewing angles, among other attributes.

A pixel of an organic light emitting diode (OLED) includes an organic light-emitting diode (OLED) that is configured to generate light having a certain luminance value that depends on the amount of current supplied to the organic light-emitting diode by the a pixel circuit.

Digital driving techniques are sometimes used for grayscale representation using organic light emitting diode (OLED) displays. In some digital driving techniques, a frame is divided into a plurality of sub-frames. Each sub-frame has an associated light emitting-period that corresponding to a grayscale. A number of sub-frames can be combined into one frame with the combined light-emitting periods representing a gray scale.

However, when a motion picture is displayed, light from pixels corresponding to a previous frame and light from adjacent pixels corresponding to the present frame can appear as being overlapped to a human observer. As a result, bright or dark contours of pixels having unintended grayscales are displayed. This is referred to as a dynamic false contour phenomenon.

Some image processing techniques (e.g., dithering, error diffusion, etc.) that are used to reduce the effects of dynamic false contour phenomenon often lead to deterioration of the image quality. Therefore, there is a need to reduce or eliminate the effects of dynamic contour phenomenon, without deteriorating the image quality.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

The disclosed technology relates to a display device configured to minimize the effects of dynamic false contour phenomenon without deteriorating image quality.

In one aspect, the display device comprises a display unit including a plurality of pixels and a timing controller. The timing controller is configured to determine a grayscale of image data of one frame unit based on a grayscale distribution of the image data of the one frame unit and to determine a driving mode based on the determined grayscale, wherein the driving mode is an arrangement of a plurality of sub-frames.

In some embodiments, the timing controller includes a grayscale deciding unit configured to process the grayscale distribution into a histogram and configured to determine the grayscale with the highest frequency within the histogram as the grayscale.

In some embodiments, the timing controller includes a driving mode determiner configured to choose the driving mode from a plurality of arrangements of sub-frames, where each arrangement has a unique sequential arrangement of sub-frames and each sub-frame has a weight value.

In some embodiments, the plurality of arrangements includes a first arrangement and a second arrangement. The first arrangement has sequentially arranged sub-frames having weight values according to the sequence of a grayscale 128, a grayscale 64, a grayscale 1, a grayscale 128, a grayscale 128, a grayscale 32, a grayscale 32, a grayscale 128, a grayscale 32, a grayscale 16, a grayscale 128, a grayscale 128, a grayscale 64, a grayscale 2, a grayscale 4, and a grayscale 8. The second arrangement has a sequentially arranged sub-frames having weight values according to the sequence of a grayscale 128, a grayscale 128, a grayscale 32, a grayscale 8, a grayscale 16, a grayscale 64, a grayscale 128, a grayscale 128, a grayscale 64, a grayscale 32, a grayscale 2, a grayscale 1, a grayscale 4, a grayscale 32, a grayscale 128, and a grayscale 128.

In some embodiments, the timing controller is configured to choose a third arrangement as the driving mode when all grayscales of the image data are less than or equal to a predetermined grayscale. The third arrangement has a sequentially arranged sub-frames having weight values according to the sequence of a grayscale 128, a grayscale 128, a grayscale 8, a grayscale 64, a grayscale 1, a grayscale 32, a grayscale 128, a grayscale 32, a grayscale 128, a grayscale 4, a grayscale 2, a grayscale 16, a grayscale 64, a grayscale 32, a grayscale 128, a grayscale 128.

In some embodiments, the timing controller is configured to choose a fourth arrangement as the driving mode. The fourth arrangement has a sequentially arranged sub-frames having weight values according to the sequence of a grayscale 128, a grayscale 64, a grayscale 128, a grayscale 8, a grayscale 32, a grayscale 128, a grayscale 1, a grayscale 32, a grayscale 16, a grayscale 4, a grayscale 128, a grayscale 2, a grayscale 32, a grayscale 128, a grayscale 64, a grayscale 128.

In some embodiments, the display device further comprises a scan driver configured to transmit a plurality of scan signals to a plurality of scan lines and a data driver configured to transmit a plurality of data signals to a plurality of data lines.

In some embodiments, each of the pixels of the display device is connected to one of the scan lines and one of the data lines, where each pixel is supplied with a data signal when a scan signal is transmitted to each pixel.

### BRIEF DESCRIPTION OF THE DRAWINGS

FIG. 1 is a schematic circuit representation of a display device according to one embodiment.

FIG. 2 is a circuit diagram of a pixel of a display device according to one embodiment.

FIG. 3 is a schematic arrangement of sub-frames according to a digital driving mode.

FIG. 4 is a schematic illustration of dynamic false contour phenomenon that may occur when a frame is configured as the arrangement of sub-frames according to the digital driving mode of FIG. 3.

FIG. 5 is an exemplary graph illustrating an actual representation of grayscales resulting from dynamic false contour phenomenon when sub-frames are configured as one frame according to the digital driving mode FIG. 3.

FIG. 6 is a schematic arrangement of sub-frames configured as one frame in a display device according to one exemplary embodiment.

FIG. 7 is a graph illustrating an actual representation of grayscales resulting from dynamic false contour phenomenon when sub-frames are configured as one frame according to the embodiment of FIG. 6.

FIG. 8 is a schematic arrangement of sub-frames configured as one frame in a display device according to another exemplary embodiment.

FIG. 9 is a graph illustrating an actual representation of grayscale resulting from dynamic false contour phenomenon when sub-frames are configured as one frame according to the embodiment of FIG. 8.

FIG. 10 is a schematic illustration of a timing controller of a display device according one embodiment.

FIG. 11 is an example histogram illustrating a grayscale distribution of an image frame.

FIG. 12 illustrates graphs of FIGS. 6 and 8 with the x-axis representing gray scale to be represented divided into intervals.

FIG. 13 is a schematic arrangement of sub-frames configured as one frame in a display device according to another exemplary embodiment.

FIG. 14 is a graph illustrating an actual representation of grayscale resulting from dynamic false contour phenomenon when sub-frames are configured as one frame according to the embodiment of of FIG. 13.

FIG. 15 is a schematic arrangement of sub-frames configured as one frame in a display device according to another exemplary embodiment.

FIG. 16 is a graph illustrating an actual representation of grayscale resulting from dynamic false contour phenomenon when sub-frames are configured as one frame according to the embodiment of FIG. 15.

### DETAILED DESCRIPTION OF CERTAIN INVENTIVE EMBODIMENTS

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In addition, in various exemplary embodiments, the first exemplary embodiment is described as a representative in which the same reference numerals are used in components with the same configuration, and other embodiments different from the first exemplary embodiment will only be described only are used.

In order to clearly explain the present invention, the portions regarded as illustrative in nature will be omitted, and the same reference numerals are used to denote the same component throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising,” will be understood to imply the inclusion of stated elements but not the exclusion of any other elements.

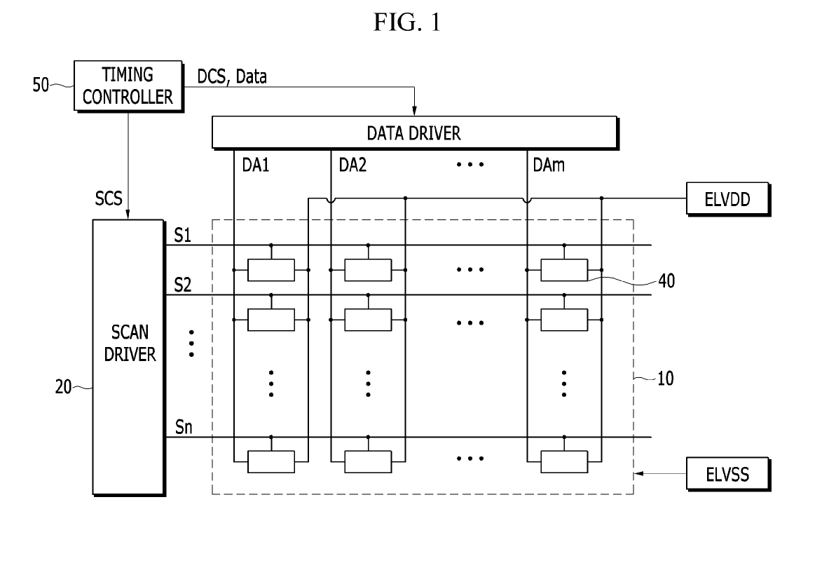

FIG. 1 is a block diagram illustrating a display device according to an exemplary embodiment of the present invention.

Referring to FIG. 1, according to an exemplary embodiment of the present invention, the display device a display unit 10 having a plurality of pixels 40 each connected to scan lines S1 to Sn and data lines DA1-Dam, a scan driver 20 that supplies a scan signal to the scan line S1-Sn to drive the scan line, a data driver 30 that supplies a data signal to the data lines DA1-Dam to drive the data line, and a timing controller 50 to control the scan driver 20 and the data driver 30.

The timing controller 50 generates a data driving control signal DCS and a scan driving control signal SCS in response to a synchronization signal supplied from the outside. The data driving control signal DCS generated from the timing controller 50 is supplied to the data driver 30, and the scan driving control signal SCS is supplied to the scan driver 20.

And, the timing controller 50 converts a video signal supplied from the outside to an image data signal Data to supply it to the data driver 30.

The data driver 30 supplies a plurality of data signals to a plurality of data lines DA1-DAm for each of a plurality of sub-frames SF included in one frame according to the data driving control signal DCS.

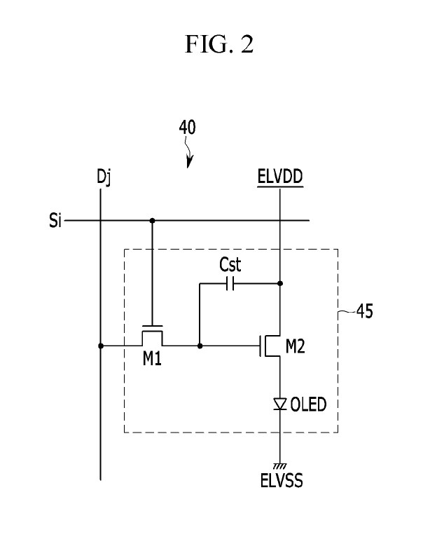

Specifically, the data driver 30 is synchronized at the time a scan signal having a gate on voltage corresponding to each sub-frame is supplied to transmit the plurality of data signals to control whether a plurality of pixels 40 are light-emitted, through the plurality of data lines DA1-DAm. The gate on voltage means a level that turns on a switching transistor such that a data signal may be transmitted to a gate electrode of a driving transistor to transmit a driving current to the organic light emitting diode (OLED). In conjunction with this, it will be described later with reference to a pixel structure of FIG. 2.

The scan driver 20 is synchronized at a starting point of the each sub-frame to supply the scan signal having the gate on voltage to a corresponding scan line among the plurality of scan lines S1-Sn. Accordingly, the plurality of pixel 40s connected to the scan line to which the scan signal having the gate on voltage among the plurality of scan lines S1-Sn is supplied may be selected. The plurality of pixel 40 selected by the scan signal are supplied with the data signal from the plurality of data lines DA1-DAm according to the corresponding sub-frame. At this time, the corresponding sub-frame means a sub-frame corresponding to a scan signal having the gate on voltage.

A first power supply ELVDD and a second power supply ELVSS supply two driving voltages required to operate the plurality of pixels 40. The two driving voltage include a first driving voltage of a high level supplied to the first power supply ELVDD and a second driving voltage of a low level supplied from the second power supply ELVSS.

Next, referring to a circuit shown in FIG. 2, the configuration of the pixel circuit of the display device of FIG. 1 will be described.

FIG. 2 illustrates a pixel circuit 45 of a pixel 40 connected to a i-th scan line Si and a j-th data line Dj of the plurality of pixels in the display device of FIG. 1. Here, the i and j are (1≦i≦n, 1≦j≦m).

According to the illustrated embodiment of FIG. 2, the pixel circuit 45 includes a switching transistor M1, a driving transistor M2, a storage capacitor Cst and an organic light emitting diode (OLED). FIG. 2 illustrates one exemplary embodiment of the driving circuit of the pixel and the present invention is not necessarily limited to such a configuration, the structure of the pixel circuit known in the art can be applied for various applications.

Specifically, the switching transistor M1 according the exemplary embodiment of FIG. 2 includes a gate electrode connected to a corresponding scan line of a plurality of scan lines, a source electrode connected to a corresponding to a data line of a plurality of data lines, and a drain electrode connected to one end of a storage capacitor Cst and a contact to which a gate electrode of a driving transistor M2 is connected.

In addition, the driving transistor M2 includes a gate electrode connected to a drain electrode of the switching transistor M1, a source electrode connected to a first power supply ELVDD, and a drain electrode connected to an anode of an organic light emitting diode OLED.

The one end of the storage capacitor is connected to the drain electrode of the switching transistor M1 and the contact to which the gate electrode of the driving transistor M2 is connected, and the other end of the storage capacitor is connected to the source electrode of the driving transistor M2 such that a voltage difference between the gate electrode and the source electrode of the driving transistor M2 is maintained during a sub-frame.

The anode of the organic light emitting diode (OLED) is connected to the drain electrode of the driving transistor M2, and the cathode of the organic light emitting diode (OLED) is connected to a second power supply ELVSS.

When the switching transistor M1 is turned-on in response to a scan signal transmitted through the corresponding scan line, the data signal transmitted through the turned-on switching transistor M1 is transmitted to the gate electrode of the driving transistor M2. Thus, the voltage difference between the gate electrode and the source electrode of the driving transistor M2 is a difference between the data signal and a first driving voltage of the first power supply, and a driving current is flowed to the driving transistor M2 in response to the corresponding voltage difference.

The driving current is transmitted to the organic light emitting diode (OLED), and the organic light emitting diode (OLED) is light-emitted in response to the transmitted driving current.

When the plurality of scan signals having the gate on voltage level are supplied to a corresponding scan line to among the plurality of scan lines S1-Sn, the plurality of switching transistors M1 connected to the corresponding scan line are turned-on. Each of the plurality of data line DA1-DAm is synchronized at the time a scan signal having the gate on voltage is supplied to receive the data signal.

The data signal transmitted to the plurality of data lines DA1-DAm through each of the plurality of switching transistors M1 turned-on is transmitted to the gate electrode of the driving transistor M2 of each of the plurality of pixels 40 such that the organic light emitting diode (OLED) of each of the plurality of pixels 40 is light-emitted or non-light emitted in response to the transmitted data signal during the corresponding sub-frame.

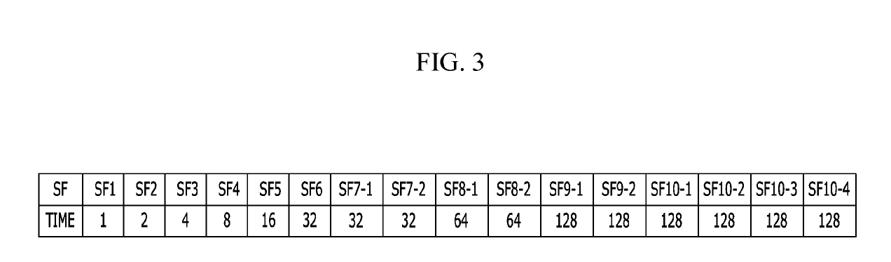

FIG. 3 is a schematic arrangement of sub-frames configured as one frame according to a digital driving mode.

An arrangement of the sub-frame in FIG. 3 is arranged in ascending order, in the following order from a sub-frame 1 (SF1) to a sub-frame 10-4 (SF10-4), the sub-frame 1 (SF1), a sub-frame 2 (SF2), a sub-frame 3 (SF3), a sub-frame 4 (SF4), a sub-frame 5 (SF5), a sub-frame 6 (SF6), a sub-frame 7-1 (SF7-1), a sub-frame 7-2 (SF7-2), a sub-frame 8-1 (SF8-1), a sub-frame 8-2 (SF8-2), a sub-frame 9-1 (SF9-1), a sub-frame 9-2 (SF9-2), a sub-frame 10-1 (SF10-1), a sub-frame 10-2 (SF10-2), a sub-frame 10-3 (SF10-3), and a sub-frame 10-4 (SF10-4). Each of the sub-frames are assigned with a light emitting period required for the representation of grayscales, and the light emitting period corresponding to each of the sub-frame in the bottom row of FIG. 3 is shown.

In such a digital driving mode, one frame is divided into a plurality of sub-frames, and a sub-frame selected in response to the video signal is turned on during one frame to represent the grayscale. For example, in order to represent grayscale. 12, the sub-frame 3 (SF3) with four-light emitting periods and the sub-frame 4 (SF4) with eight-light emitting periods are once turned-on for each during one frame, in order to represent grayscale. 127, the sub-frame 1 (SF1) to the sub-frame 7-2 (SF7-2) are all turned-on during one frame, and in order to represent grayscale. 128, the sub-frame 8 SF8 is turned-on during one frame.

However, in a case where a motion picture is played, or the observer's eye to observe still images is moved, a dynamic false contour phenomenon (Dynamic False Contour) will occur due to a visual property of human. In other words, light of the previous frame and the current frame between the adjacent pixels is overlapped and observed by the observer's eye, and thus bright or dark grayscales, which is not grayscales to wish the representation, are displayed.

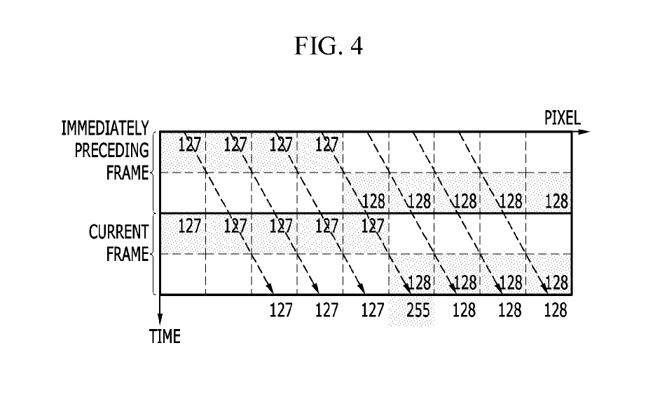

FIG. 4 is a schematic illustration of dynamic false contour phenomenon that can occur under a digital driving mode when sub-frames of a frame are configured as in FIG. 3.

For example, a case where the grayscale. 127 and the grayscale. 128 in which an image is represented in the adjacent pixel are moved from left to right (from the grayscale. 127 to the grayscale. 128) at a speed of 1 pixel for a frame (1 ppf, pixel per a frame) will be described. In the sub-frame as shown in FIG. 3, in order to represent the grayscale. 127, the sub-frame 1 (SF1) to the sub-frame 7-2 (SF7-2) should be all turned-on during one frame, and in order to represent the grayscale. 128, the sub-frame 8-1 (SF8-1) and the sub-frame 8-2 (SF8-2) should be turned-on during one frame.

However, since the sub-frame 7-2 (SF7-2) and the sub-frame 8-1 (SF8-1) are adjacent to each other, when an image between the immediately preceding frame and the current frame is moved in the right at the speed of 1 ppf, the grayscale. 128 is represented from the immediately preceding frame, at a right pixel adjacent to the pixel at which the grayscale. 127 is represented in the current frame, that is, in the immediately preceding frame, the grayscale. 128 is represented in the current frame, and at the pixel at which the grayscale. 128 is represented in the current frame, the 255 grayscales is represented. Thus, the dynamic false contour phenomenon is generated.

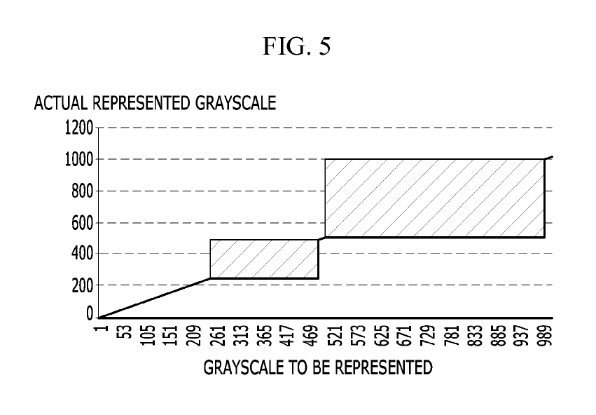

FIG. 5 is a drawing illustrating a grayscale represented when a dynamic false contour phenomenon of a digital driving mode of the prior art is generated.

Due to the above-mentioned reasons, when one frame is configured in the arrangement mode of sub-frames as shown in FIG. 3, the grayscale range that can generate a dynamic false contour phenomenon is shown in FIG. 5 as the hatched. That is, the dynamic false contour phenomenon will occur within a grayscale range of approximately 70% of the entire grayscale to be represented.

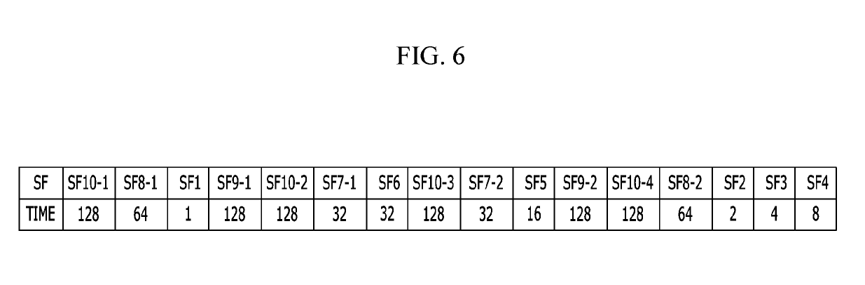

In order to solve problems of the existing technologies, according to the exemplary embodiment of the present invention, one of arrangement modes of the sub-frames to configure one frame of the display device is shown in FIG. 6.

FIG. 6 is a drawing illustrating an example of the configuration of a sub-frame to configure one frame in a display device according to an exemplary embodiment of the present invention.

The arrangement mode of the sub-frames shown in FIG. 6 is different from the arrangement mode of FIG. 3. For example, in order to reduce dynamic false contour phenomenon, the arrangement of the sub-frame in FIG. 6 is arranged, in the following order from the sub-frame 10-1 (SF10-1) to the sub-frame 4 (SF4), the sub-frame 10-1 (SF10-1), the sub-frame 8-1 (SF8-1), the sub-frame 1 (SF1), the sub-frame 9-1 (SF9-1), the sub-frame 10-2 (SF10-2), the sub-frame 7-1 (SF7-1), the sub-frame 6 (SF6), the sub-frame 10-3 (SF10-3), the sub-frame 7-2 (SF7-2), the sub-frame 5 (SF5), the sub-frame 9-2 (SF9-2), the sub-frame 10-4 (SF10-4), the sub-frame 8-2 (SF8-2), the sub-frame 2 (SF2), the sub-frame 3 (SF3), and the sub-frame 4 (SF4). Similarly to FIG. 3, each of the sub-frames are assigned with a light emitting period required for the representation of grayscales, and the light emitting period corresponding to each of the sub-frame in the bottom row of FIG. 6 is shown.

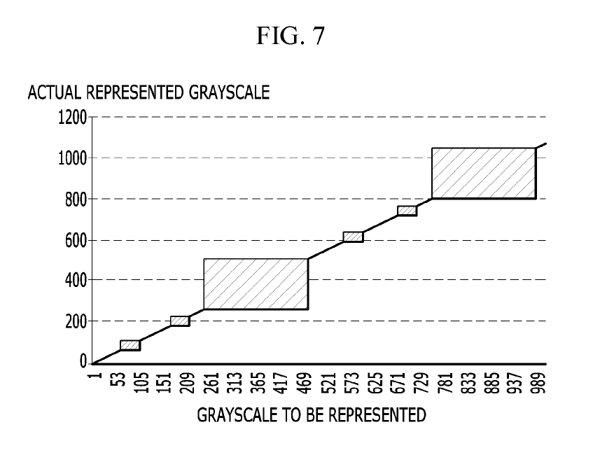

FIG. 7 is a drawing illustrating a grayscale represented when a dynamic false contour phenomenon is generated in a case where one frame is configured as a sub-frame of FIG. 6.

If one frame is configured by sub-frames of an arrangement mode shown in FIG. 6, the dynamic false contour phenomenon can be generated in a grayscale area marked as square blocks in FIG. 7. In the arrangement mode of the sub-frames according to the exemplary embodiment of the present invention, the grayscale range in which the dynamic false contour phenomenon is generated can be reduced, compared to a mode of the prior art shown in FIG. 5.

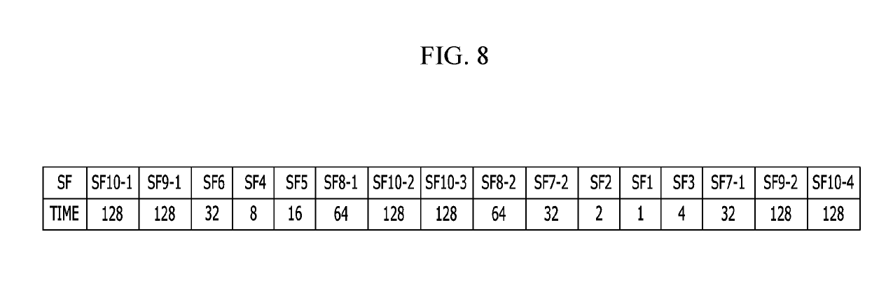

FIG. 8 is a drawing illustrating an example of the configuration of sub-frames to configure one frame and their arrangements in a display device according to an exemplary embodiment of the present invention.

In order to reduce the dynamic false contour phenomenon, the arrangement of the sub-frame in FIG. 8 is arranged, in the following order from the sub-frame 10-1 (SF 10-1) to the sub-frame 10-4 (SF10-4), for example, the sub-frame 10-1 (SF10-1), the sub-frame 9-1 (SF9-1), the sub-frame 6 (SF6), the sub-frame 4 (SF4), the sub-frame 5 (SF5), the sub-frame 8-1 (SF8-1), the sub-frame 10-2 (SF10-2), the sub-frame 10-3 (SF10-3), the sub-frame 8-2 (SF8-2), the sub-frame 7-2 (SF7-2), the sub-frame 2 (SF2), the sub-frame 1 (SF1), the sub-frame 3 (SF3), the sub-frame 7-1 (SF7-1), the sub-frame 9-2 (SF9-2), and the sub-frame 10-4 (SF10-4). Similarly to FIG. 3, each of the sub-frames are assigned with a light emitting period required for the representation of grayscales, and the light emitting period corresponding to each of the sub-frame in the bottom row of FIG. 6 is shown.

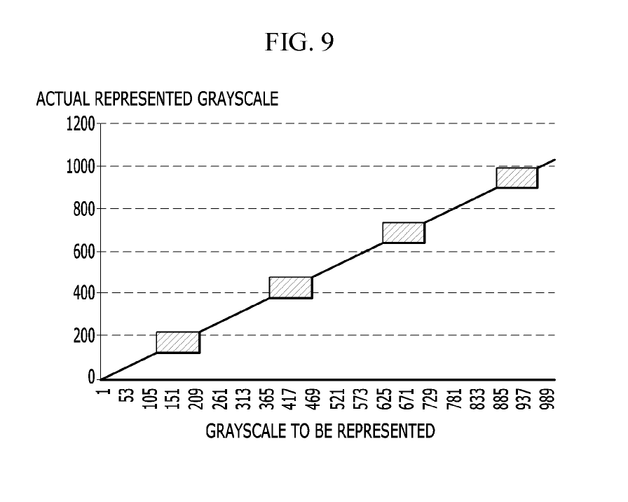

FIG. 9 is a drawing illustrating a grayscale represented when a dynamic false contour phenomenon is generated in a case where one frame is configured as a sub-frame of FIG. 8.

If one frame is configured by sub-frames of an arrangement mode shown in FIG. 8, the dynamic false contour phenomenon can be generated in a grayscale area marked as square blocks in FIG. 9. In the arrangement mode of the sub-frames according to the exemplary embodiment of the present invention, the grayscale range in which the dynamic false contour phenomenon is generated can be reduced, compared to a mode of the prior art shown in FIG. 5.

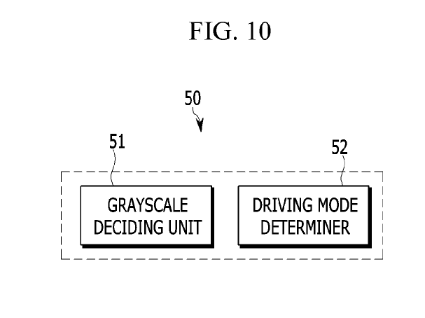

FIG. 10 is a drawing illustrating a specific configuration of a timing controller 50 in a display device according to an exemplary embodiment of the present invention.

Referring to FIG. 10, the timing controller 50 includes a grayscale deciding unit 51 to decide a grayscale of an image data of one frame unit and a driving mode determiner 52 to determine a driving mode.

The grayscale deciding unit 51 decides grayscales of the corresponding frame based on grayscale data included in the video signal supplied by the timing controller 50. Specifically, the grayscale deciding unit 51 processes the grayscale distribution of grayscale data included in the video signal of one frame unit as a histogram to decide the grayscale with the largest frequency as a grayscale of the image data of the one frame unit.

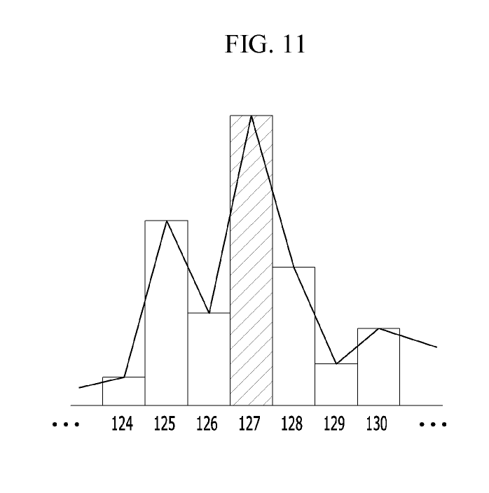

The decision mode of the grayscale deciding unit 51 will be described in detail referring to FIG. 11.

FIG. 11 is a diagram illustrating that an example of a grayscale distribution of each pixel unit for one frame image is represented as a histogram.

It will assume that the most pixels with grayscale of grayscale. 127 are distributed in one frame image in FIG. 11. In this case, that is, when grayscales of each pixel unit of one frame image is distributed as shown in FIG. 11, the grayscale deciding unit 51 decides the grayscale of the corresponding one frame image as the grayscale. 127.

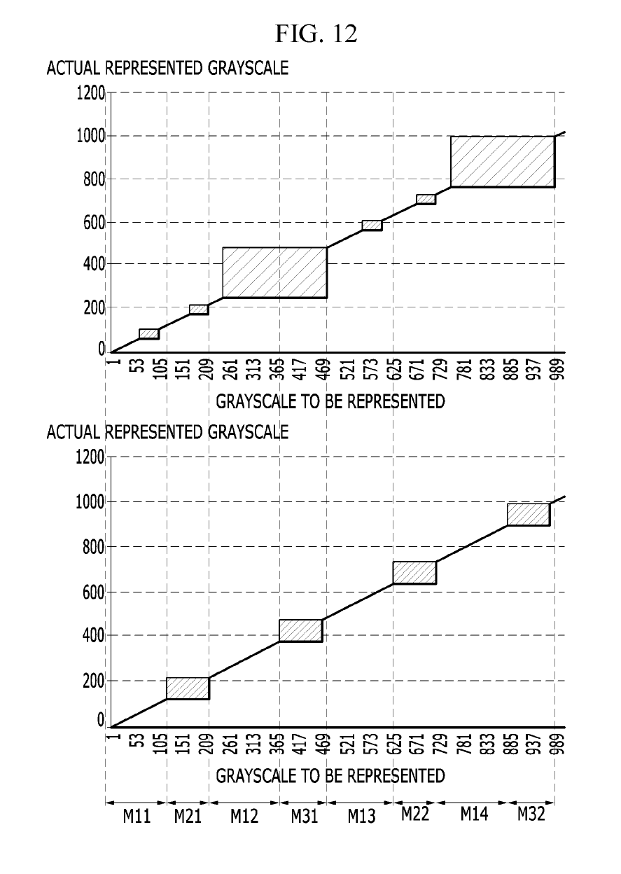

The driving mode determiner 52 determines a driving mode according to the decision result of the grayscale deciding unit 51. Specifically, according to the grayscale of the image data of one frame unit decided in the grayscale deciding unit 51, one of the plurality of sub-frame arrangement modes is determined as a driving mode of the corresponding frame. Referring to FIG. 12, it will be described later.

FIG. 12 is a drawing illustrating dynamic false contour generation areas according to grayscales shown in FIGS. 7 and 9 together. As shown in FIG. 12, a grayscale range is divided into a plurality of intervals.

Looking at a case of the first −1 interval M11, when configured one frame by the sub-frame of FIG. 6 (hereinafter, referring to as ‘a first driving mode’), the dynamic false contour phenomenon is generated in part, but if when configured one frame by the sub-frame of FIG. 8 (hereinafter, referring to as ‘a second driving mode’), the dynamic false contour phenomenon does not occur. Therefore, when the grayscale of the image data of the one frame unit falls within the first −1 interval M11, the dynamic false contour phenomenon can be further reduced by selecting the sub-frame arrangement mode to the second driving mode.

Looking at a case of the second −1 interval M21, in the case of the first driving mode, the dynamic false contour phenomenon is generated in part, but in the case of the second driving mode, the dynamic false contour phenomenon is generated in the entire interval. Thus when the grayscale of the image data of the one frame unit falls within the second −1 interval M21, the dynamic false contour phenomenon can be further reduced by selecting the sub-frame arrangement mode to the first driving mode.

Looking at a case of the first −2 interval M12, in the case of the first driving mode, the dynamic false contour phenomenon is generated in the entire interval, but in the case of the second driving mode, the dynamic false contour phenomenon does not generate in the entire interval. Therefore, when the grayscale of the image data of the one frame unit falls within the first −2 interval M12, the dynamic false contour phenomenon can be further reduced by selecting the sub-frame arrangement mode to the second driving mode.

Looking at a case of the third −1 interval M31, in the cases of the first driving mode and the second driving mode, the dynamic false contour phenomenon is almost generated in the entire interval. Therefore, when the grayscale of the image data of the one frame unit falls within the third −1 interval M31, even if the sub-frame arrangement mode is selected to either the first driving mode or the second driving mode, the same results may be obtained in terms of the generation of the dynamic false contour phenomenon.

Looking at a case of the first-3 interval M13, in the case of the first driving mode, the dynamic false contour phenomenon is generated in the entire interval, but in the case of the second driving mode, the dynamic false contour phenomenon does not generate in the entire interval. Therefore, when the grayscale of the image data of the one frame unit falls within the first −2 interval M12, the dynamic false contour phenomenon can be further reduced by selecting the sub-frame arrangement mode to the second driving mode.

Looking at a case of the second −2 interval M22, in the case of the first driving mode, the dynamic false contour phenomenon is generated in part, but in the case of the second driving mode, the dynamic false contour phenomenon is generated in the entire interval. Thus, when the grayscale of the image data of the one frame unit falls within the second −2 interval M22, the dynamic false contour phenomenon can be further reduced by selecting the sub-frame arrangement mode to the first driving mode.

Looking at a case of the first-4 interval M14, in the case of the first driving mode, the dynamic false contour phenomenon is generated in the almost entire interval, but in the case of the second driving mode, the dynamic false contour phenomenon does not generate in the entire interval. Therefore, when the grayscale of the image data of the one frame unit falls within the first −4 interval M14, the dynamic false contour phenomenon can be further reduced by selecting the sub-frame arrangement mode to the second driving mode.

Looking at a case of the third −2 interval M32, in the cases of the first driving mode and the second driving mode, the dynamic false contour phenomenon is generated in the almost entire interval. Therefore, when the grayscale of the image data of the one frame unit falls within the third −2 interval M32, even if the sub-frame arrangement mode is selected to either the first driving mode or the second driving mode, the same results may be obtained in terms of the generation of the dynamic false contour phenomenon.

Therefore, if the deciding unit 51 decides the grayscale of one frame, the driving mode determiner 52 determines the driving mode depending on whether the decided grayscale fails within any interval of FIG. 12. For example, as shown in FIG. 11, if the grayscale of the one frame is decided as the grayscale. 127, since the grayscale. 127 falls within the first −1 interval M1-1, it is driven by selecting the sub-frame arrangement mode to the first driving mode.

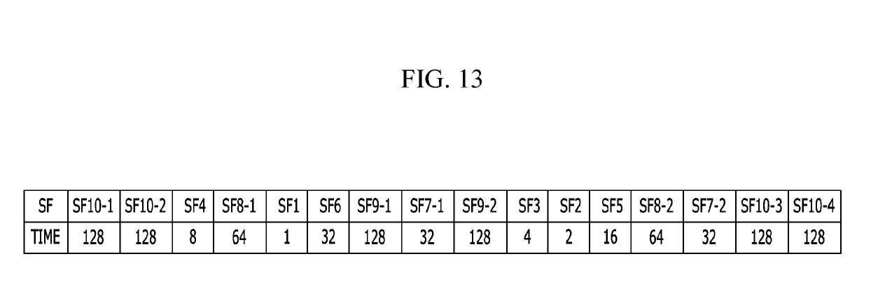

FIG. 13 is a drawing illustrating an example of the configuration of a sub-frame to configure one frame in a display device according to an exemplary embodiment of the present invention.

In order to reduce generation of the dynamic false contour phenomenon, the arrangement of the sub-frame in FIG. 13 is arranged, in the following order from the sub-frame 10-1 (SF10-1) to the sub-frame 10-4 (SF10-4), for example, the sub-frame 10-1 (SF10-1), the sub-frame 10-2 (SF10-2), the sub-frame 4 (SF4), the sub-frame 8-1 (SF8-1), the sub-frame 1 (SF1), the sub-frame 6 (SF6), the sub-frame 9-1 (SF9-1), the sub-frame 7-1 (SF7-1), the sub-frame 9-2 (SF9-2), the sub-frame 3 (SF3), the sub-frame 2 (SF2), the sub-frame 5 (SF5), the sub-frame 8-2 (SF8-2), the sub-frame 7-2 (SF7-2), the sub-frame 10-3 (SF10-3), and the sub-frame 10-4 (SF 10-4). Similarly to FIG. 3, each of the sub-frames are assigned with a light emitting period required for the representation of grayscales, and the light emitting period corresponding to each of the sub-frame in the bottom row of FIG. 13 is shown.

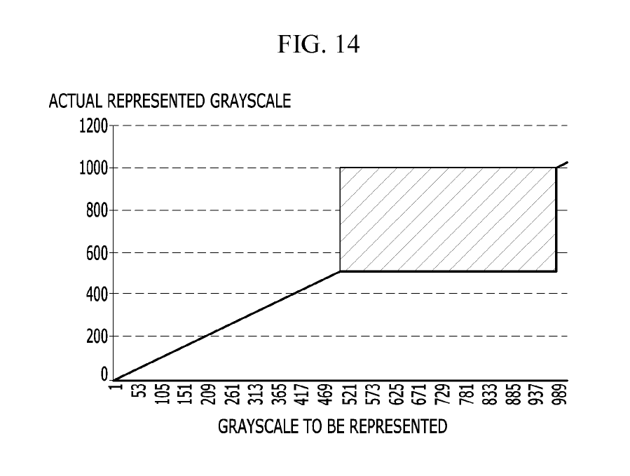

FIG. 14 is a drawing illustrating a grayscale represented when a dynamic false contour phenomenon is generated in a case where one frame is configured as a sub-frame of FIG. 13.

If one frame is configured by sub-frames of an arrangement mode shown in FIG. 13, the dynamic false contour phenomenon can be generated in a grayscale area marked as square blocks in FIG. 14. In the arrangement mode of the sub-frames according to the exemplary embodiment of the present invention, the grayscale range in which the dynamic false contour phenomenon is generated can be reduced, compared to a mode of the prior art shown in FIG. 5.

Referring to FIG. 14, in this case, if it is less than approximately grayscale 500, the dynamic false contour phenomenon may not generate, and if it is greater than approximately grayscale 500, the dynamic false contour phenomenon may generate. Therefore, it is known that the configuration of the sub-frame is suitable for use with an image with a grayscale below the center grayscale.

That is, in a case where a grayscale of image to be represented is below the center grayscale, if one frame configured by the sub-frame of FIG. 13 (hereinafter, referring to as ‘a third driving mode’) is driven, the dynamic false contour phenomenon can be minimized.

In order to apply the above-mentioned the first driving mode, the second driving mode and the third driving mode according to the grayscale of the video signal to be input, there is a need to analyze and decide the grayscale of the video signal to be input. Therefore, one or more storage devices, which are not a frame memory, are required in the timing controller 50. If these additional storage devices can not be used, there is a need to configure the sub-frame such that the generation of the dynamic false contour phenomenon from the entire grayscale may be minimized.

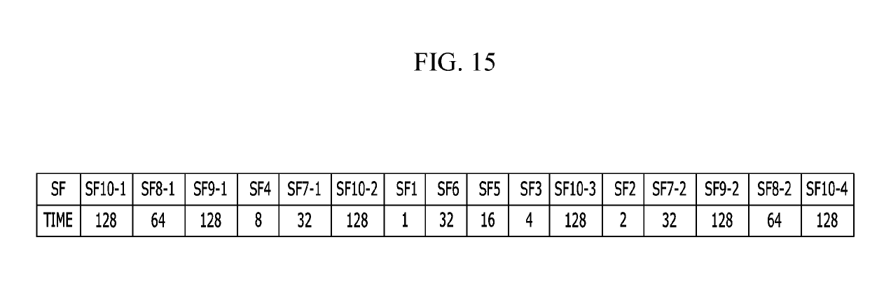

FIG. 15 is a drawing illustrating an example of the configuration a sub-frame to configure one frame in a display device according to an exemplary embodiment of the present invention.

In order to reduce the dynamic false contour phenomenon from the entire grayscale, the arrangement mode of the sub-frames in FIG. 15 is arranged, in the following order from the sub-frame 10-1 (SF10-1) to the sub-frame 10-4 (SF10-4), for example, the sub-frame 10-1 (SF10-1), the sub-frame 8-1 (SF8-1), the sub-frame 9-1 (SF9-1), the sub-frame 4 (SF4), the sub-frame 7-1 (SF7-1), the sub-frame 10-2 (SF10-2), the sub-frame 1 (SF1), the sub-frame 6 (SF6), the sub-frame 5 (SF5), the sub-frame 3 (SF3), the sub-frame 10-3 (SF10-3), the sub-frame 2 (SF2), the sub-frame 7-2 (SF7-2), the sub-frame 9-2 (SF9-2), the sub-frame 8-2 (SF8-2), and the sub-frame 10-4 (SF10-4). Similarly to FIG. 3, each of the sub-frames are assigned with a light emitting period required for the representation of grayscales, and the light emitting period corresponding to each of the sub-frame in the bottom row of FIG. 15 is shown.

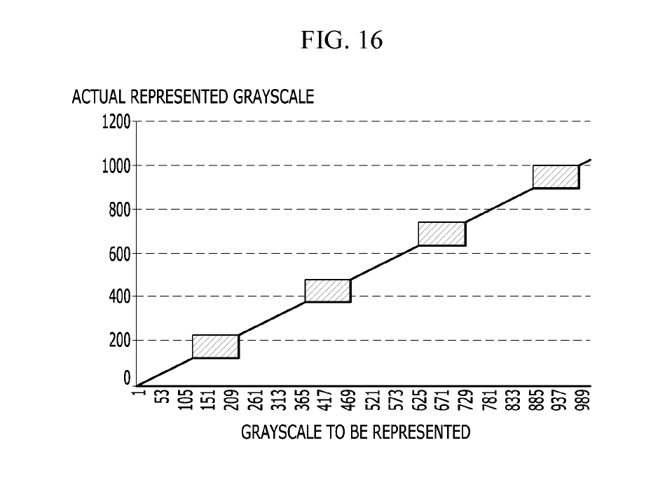

FIG. 16 is a drawing illustrating a grayscale range represented when a dynamic false contour phenomenon can be generated in a case where one frame is configured as a sub-frame of FIG. 15.

Referring to the arrangement mode shown in FIG. 16, in this configuration of the sub-frame, it can be seen that the generation of the false contour phenomenon is generally minimized.

That is, in a case where additional storage devices can not be used, if one frame configured by the sub-frame of FIG. 15 (hereinafter, referring to as ‘a fourth driving mode’) is driven, the generation of the dynamic false contour phenomenon may be minimized.

The present invention has been described in conjunction with specific embodiments of the present invention, but it is just illustrative and is not limited thereto. The above-mentioned embodiments can be changed or modified without departing from the scope of the present invention by a person of an ordinary skill in the art, and these changes or modifications fall within the scope of the present invention. In addition, the materials of each constituent element described in the specification can be selected from and replaced by the known various materials by a person of an ordinary skill in the art. In addition, some of constituent elements described in the specification can be omitted or added to improve performance without performance degradation by a person of an ordinary skill in the art. Furthermore, the sequence of steps of the methods described in the specification can be changed depending on the process environment or equipment by a person of an ordinary skill in the art. Therefore, the scope of the present invention is not determined by above-mentioned embodiments, and must be determined by the appended claims and their equivalents.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display unit including a plurality of pixels; and
a timing controller configured to determine a grayscale of image data of one frame unit based on a grayscale distribution of the image data of the one frame unit and to determine a driving mode based on the determined grayscale, wherein
the driving mode is an arrangement of a plurality of sub-frames.

2. The display device of claim 1, wherein the timing controller includes:
a grayscale deciding unit configured to process the grayscale distribution into a histogram and configured to determine the grayscale with the highest frequency within the histogram as the grayscale of the image data of the one frame unit

3. The display device of claim 2, wherein the driving mode includes a plurality of arrangements of sub-frames, each arrangement having a unique sequential arrangement of sub-frames, each sub-frame having a weight value, and the timing controller includes a driving mode determiner configured to choose the driving mode from the plurality of arrangements of sub-frames, as a driving mode of the corresponding frame according to the grayscale of the image data of the one frame unit.

4. The display device of claim 3, wherein the plurality of arrangements includes a first arrangement and a second arrangement,
wherein the first arrangement has sequentially arranged sub-frames having weight values according to the sequence of a grayscale 128, a grayscale 64, a grayscale 1, a grayscale 128, a grayscale 128, a grayscale 32, a grayscale 32, a grayscale 128, a grayscale 32, a grayscale 16, a grayscale 128, a grayscale 128, a grayscale 64, a grayscale 2, a grayscale 4, and a grayscale 8, and
wherein the second arrangement has a sequentially arranged sub-frames having weight values according to the sequence of a grayscale 128, a grayscale 128, a grayscale 32, a grayscale 8, a grayscale 16, a grayscale 64, a grayscale 128, a grayscale 128, a grayscale 64, a grayscale 32, a grayscale 2, a grayscale 1, a grayscale 4, a grayscale 32, a grayscale 128, and a grayscale 128.

5. The display device of claim 1, wherein the timing controller is configured to choose a third arrangement as the driving mode when all grayscales of the image data are less than or equal to a predetermined grayscale, and
wherein the third arrangement has a sequentially arranged sub-frames having weight values according to the sequence of a grayscale 128, a grayscale 128, a grayscale 8, a grayscale 64, a grayscale 1, a grayscale 32, a grayscale 128, a grayscale 32, a grayscale 128, a grayscale 4, a grayscale 2, a grayscale 16, a grayscale 64, a grayscale 32, a grayscale 128, a grayscale 128.

6. The display device of claim 1, wherein the timing controller is configured to choose a fourth arrangement as the driving mode, and
wherein the fourth arrangement has a sequentially arranged sub-frames having weight values according to the sequence of a grayscale 128, a grayscale 64, a grayscale 128, a grayscale 8, a grayscale 32, a grayscale 128, a grayscale 1, a grayscale 32, a grayscale 16, a grayscale 4, a grayscale 128, a grayscale 2, a grayscale 32, a grayscale 128, a grayscale 64, a grayscale 128.

7. The display device of claim 1, further comprising:
a scan driver configured to transmit a plurality of scan signals to a plurality of scan lines; and
a data driver configured to transmit a plurality of data signals to a plurality of data lines.

8. The display device of claim 7, wherein each of the pixels is connected to one of the scan lines and one of the data lines, and wherein each pixel is supplied with a data signal when a scan signal is transmitted to each pixel.
